(19) United States
(12) Patent Application Publication
(10) Pub. No.: US 2026/0119798 A1
(43) Pub. Date: Apr. 30, 2026

(54) METHOD AND ELECTRONIC DEVICE FOR DETECTING PERSONAL INFORMATION

(71) Applicant: SAMSUNG ELECTRONICS CO., LTD., Suwon-si (KR)

(72) Inventor: Sangho LEE, Suwon-si (KR)

(73) Assignee: SAMSUNG ELECTRONICS CO., LTD., Suwon-si (KR)

(21) Appl. No.: 19/331,325

(22) Filed: Sep. 17, 2025

Related U.S. Application Data
(63) Continuation of application No. PCT/KR2025/013027, filed on Aug. 27, 2025.

(30) Foreign Application Priority Data
Oct. 31, 2024 (KR) 10-2024-0152964

(51) Int. Cl. G06F 40/295; G06F 40/30; G06F 40/58

(52) U.S. Cl. CPC G06F 40/295; G06F 40/30; G06F 40/58

(57) ABSTRACT

Provided is a method, performed by an electronic device, of identifying personal information. The method includes obtaining a first text in a first language, detecting personal information in the first text, obtaining a second text by translating the first text into a second language, identifying a first score based on a pronunciation analysis of the personal information and the second text, identifying a second score based on a semantic analysis of the personal information and the second text, and detecting, in the second text, personal information elements corresponding to the personal information in the first text, based on the first score and the second score.

### CROSS-REFERENCE TO RELATED APPLICATIONS

This application is a continuation application of International Application No. PCT/KR2025/013027, filed on Aug. 27, 2025, which claims priority to Korean Patent Application No. 10-2024-0152964, filed on Oct. 31, 2024, the disclosures of which are incorporated by reference herein in their entireties.

### BACKGROUND

### 1. Field

The disclosure relates to an electronic device and method for detecting personal information elements in text by using a single cross-lingual model capable of detecting personal information in a plurality of different languages.

### 2. Description of Related Art

As interest in and the importance of personal information protection increase, regulations to protect personal information have been continuously introduced, and concurrently, various technologies for protecting personal information have also been developed. In particular, the importance of technology for accurately detecting personal information within text that includes such information is growing. However, the manner in which personal information is expressed varies according to language, and thus, when the language differs, detecting personal information is challenging, or a new detection method may need to be applied each time. In particular, as the scale of data increases, such inefficiency is further exacerbated. Therefore, a need is emerging for a method capable of efficiently detecting the same personal information in various languages, irrespective of the language.

### SUMMARY

According to an aspect of the disclosure, there is provided a method, performed by an electronic device, of detecting personal information, the method including: obtaining a first text in a first language; detecting personal information in the first text; obtaining a second text by translating the first text into a second language; identifying a first score based on a pronunciation analysis of the personal information and the second text; identifying a second score based on a semantic analysis of the personal information and the second text; and detecting, in the second text, personal information elements corresponding to the personal information in the first text, based on the first score and the second score.

The identifying the first score may include: converting the personal information and the second text into International Phonetic Alphabet (IPA) transcriptions; and identifying the first score representing a similarity between an IPA transcription of the second text and an IPA transcription of the personal information.

The identifying the first score may include applying a weight to the similarity between the IPA transcription of the second text and the IPA transcription of the personal information, based on a phonetic symbol group generated by grouping similar phonetic symbols.

The identifying the second score may include identifying the second score representing relevance between the first text and the second text, by applying an attention mechanism.

The obtaining of the second text may include: translating the first text into a third language, which is an intermediate language; and obtaining the second text by translating, into the second language, a third text, which is a result of the translating into the third language.

The method may further include applying, to at least one of the first score or the second score, a weight corresponding to at least one of language characteristics or personal information characteristics.

The method may further include determining a priority between the pronunciation analysis and the semantic analysis by comparing at least one of the first score or the second score with a threshold value.

The method may further include: obtaining a user input to select the second language; and applying settings for performing the pronunciation analysis and the semantic analysis, based on identification information about the first language and the second language.

The method may further include determining whether to perform the pronunciation analysis, based on the identification information about the first language and the second language.

The method may further include determining a protection level for a document including the second text, based on the personal information elements identified in the second text.

According to an aspect of the disclosure, there is provided an electronic device including: a communication interface; at least one processor; and a memory storing instructions, wherein the instructions, when executed by the at least one processor, cause the electronic device to: obtain a first text in a first language;

determine personal information in the first text, obtain a second text by translating the first text into a second language; identify a first score based on a pronunciation analysis of the personal information and the second text; identify a second score based on a semantic analysis of the personal information and the second text; and determine, in the second text, personal information elements corresponding to the personal information in the first text, based on the first score and the second score.

The instructions, when executed by the at least one processor, may may cause the electronic device to: convert the personal information and the second text into International Phonetic Alphabet (IPA) transcriptions; and identify the first score representing a similarity between an IPA transcription of the second text and an IPA transcription of the personal information.

The instructions, when executed by the at least one processor, may cause the electronic device to apply a weight to the similarity between the IPA transcription of the second text and the IPA transcription of the personal information, based on a phonetic symbol group generated by grouping similar phonetic symbols.

The instructions, when executed by the at least one processor, may cause the electronic device to identify the second score representing relevance between the first text and the second text, by applying an attention mechanism.

The instructions, when executed by the at least one processor, may cause the electronic device to translate the first text into a third language, which is an intermediate language, and obtain the second text by translating, into the second language, a third text, which is a result of the translating into the third language.

The instructions, when executed by the at least one processor, may cause the electronic device to apply, to at least one of the first score or the second score, a weight corresponding to at least one of language characteristics or personal information characteristics.

The instructions, when executed by the at least one processor, may cause the electronic device to determine a priority between the pronunciation analysis and the semantic analysis by comparing at least one of the first score or the second score with a threshold value.

The instructions, when executed by the at least one processor, may cause the electronic device to obtain a user input to select the second language, and apply settings for performing the pronunciation analysis and the semantic analysis, based on identification information about the first language and the second language.

The instructions, when executed by the at least one processor, may cause the electronic device to determine whether to perform the pronunciation analysis, based on the identification information about the first language and the second language.

According to an aspect of the disclosure, there is provided a non-transitory computer-readable recording medium having recorded thereon a program for causing a computer to execute a method including: obtaining a first text in a first language; determining personal information in the first text; obtaining a second text by translating the first text into a second language; identifying a first score based on a pronunciation analysis of the personal information and the second text; identifying a second score based on a semantic analysis of the personal information and the second text; and determining, in the second text, personal information elements corresponding to the personal information in the first text, based on the first score and the second score.

### BRIEF DESCRIPTION OF THE DRAWINGS

The above and other aspects and/or features of embodiments of the present disclosure will be more apparent from the following description taken in conjunction with the accompanying drawings, in which:

FIG. 1 is a diagram for illustrating an operation, performed by an electronic device, of detecting cross-lingual personal information, according to an embodiment of the disclosure;

FIG. 2 is a flowchart for illustrating an operation, performed by an electronic device, of detecting personal information, according to an embodiment of the disclosure;

FIG. 3 is a diagram for illustrating an operation, performed by an electronic device, of detecting personal information, according to an embodiment of the disclosure;

FIG. 4 is a diagram for illustrating an operation of a pronunciation analysis module of a cross-lingual model, according to an embodiment of the disclosure;

FIG. 5 is a diagram illustrating an operation of a semantic analysis module of a cross-lingual model, according to an embodiment of the disclosure;

FIG. 6 is a diagram for illustrating an operation, performed by an electronic device, of detecting personal information by combining pronunciation analysis and semantic analysis, according to an embodiment of the disclosure;

FIG. 7 is a diagram illustrating an example of an operation, performed by an electronic device, of detecting cross-lingual personal information, according to an embodiment of the disclosure;

FIG. 8 is a diagram illustrating an example of an operation, performed by an electronic device, of detecting cross-lingual personal information, according to an embodiment of the disclosure;

FIG. 9 is a flowchart for illustrating an operation, performed by an electronic device, of applying settings for personal information detection, according to an embodiment of the disclosure;

FIG. 10 is a flowchart for illustrating an operation, performed by an electronic device, of detecting personal information, according to an embodiment of the disclosure;

FIG. 11 is a block diagram illustrating a configuration of an electronic device according to an embodiment of the disclosure; and

FIG. 12 is a block diagram illustrating a configuration of a server according to an embodiment of the disclosure.

### DETAILED DESCRIPTION

The terms used herein will be briefly described, and then the disclosure will be described in detail. As used herein, the expression “at least one of a, b, or c” may indicate only a, only b, only c, both a and b, both a and c, both b and c, all of a, b, and c, or variations thereof.

Although the terms used herein are selected from among common terms that are currently widely used in consideration of their functions in the disclosure, the terms may be different according to an intention of one of ordinary skill in the art, a precedent, or the advent of new technology. In addition, in certain cases, there are also terms arbitrarily selected by the applicant, and in this case, the meaning thereof will be defined in detail in the description. Therefore, the terms used herein are not merely designations of the terms, but the terms are defined based on the meaning of the terms and content throughout the disclosure.

The singular expression may also include the plural meaning as long as it is not inconsistent with the context. All the terms used herein, including technical and scientific terms, may have the same meanings as those generally understood by those of skill in the art related to the present disclosure. In addition, although the terms such as ‘first’ or ‘second’ may be used in the disclosure to describe various elements, these elements should not be limited by the terms. These terms are only used to distinguish one element from another element.

Throughout the disclosure, when a part “includes” a component, it means that the part may additionally include other components rather than excluding other components as long as there is no particular opposing recitation. In addition, as used herein, the terms such as “ . . . er (or)”, “ . . . unit”, “ . . . module”, etc., denote a unit that performs at least one function or operation, which may be implemented as hardware or software or a combination thereof.

Hereinafter, embodiments of the disclosure will be described in detail with reference to the accompanying drawings to allow those of skill in the art to easily carry out the embodiments. The disclosure may, however, be embodied in many different forms and should not be construed as being limited to embodiments set forth herein. In addition, in order to clearly describe the disclosure, portions that are not relevant to the description of the disclosure are omitted, and similar reference numerals are assigned to similar elements throughout the disclosure.

Hereinafter, the disclosure will be described in detail with reference to the accompanying drawings.

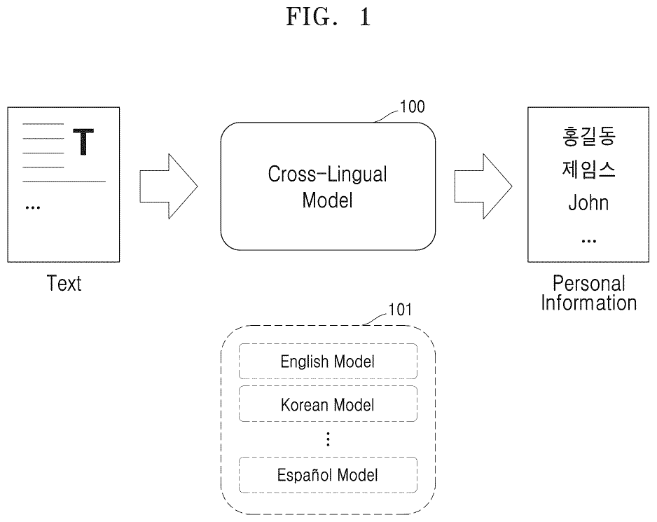

FIG. 1 is a diagram for illustrating an operation, performed by an electronic device, of detecting (e.g., identifying) cross-lingual personal information, according to an embodiment of the disclosure.

In an embodiment of the disclosure, the electronic device may detect personal information from text by using a cross-lingual model 100. Personal information may include a name, a gender, a date of birth, an address, and the like, and may refer to all types of information for identifying an individual.

Although it may be personal information with the same content, methods of expression may differ by language. Thus, when the language is changed, separate language models 101 may be required to detect personal information in the corresponding language. For example, an English model is used for detecting personal information written in English, a Korean model is used for detecting personal information written in Korean, and a Spanish model may be used for detecting personal information written in Spanish.

The cross-lingual model 100 of the disclosure supports a cross-lingual personal information detection function that may detect personal information regardless of the language of the input text. For example, “ [symbol] ” is a Korean name (Hong Gil-Dong) written in Korean, “ [symbol] ” is an English name (James) written in Korean, and “John” is an English name written in English. The cross-lingual model 100 may detect personal information elements in text written in different languages without changing the model. To this end, the cross-lingual model 100 may perform operations of using additional information that reflects features of personal information, based on personal information elements detected in one language, to directly detect the corresponding personal information in other languages.

In an embodiment of the disclosure, the cross-lingual model 100 may perform a pronunciation analysis operation to reflect the characteristic that the pronunciation of personal information remains similar even when the language is changed. In addition, the cross-lingual model 100 may perform a semantic analysis operation to reflect the characteristic that the meaning of personal information remains similar even when the language is changed and thus the word order is changed. Based on personal information identifiable in a particular language, the cross-lingual model 100 may detect the same personal information in another language by using a combination of pronunciation analysis and semantic analysis. In the disclosure, the particular language may be referred to as a ‘source language’ and the other language may be referred to as a ‘target language’, and for distinction, the source language and the target language may also be referred to as a first language and a second language, respectively.

In an embodiment of the disclosure, the electronic device may be a device capable of performing a personal information detection operation, and displaying and providing text and/or personal information detection results. For example, the electronic device may be implemented as various types and forms of electronic devices including a display. The electronic device may include devices capable of displaying visual information via a display, such as a smart television (TV), a smart phone, a tablet personal computer (PC), or a laptop PC, but is not limited thereto.

In an embodiment of the disclosure, the electronic device may be a device capable of performing a personal information detection operation and providing text and/or personal information detection results to a user device. For example, in the disclosure, the electronic device and the user device may be implemented in a server-client device structure.

Detailed operations, performed by the electronic device, of detecting and providing personal information in multiple languages by using the cross-lingual model 100 will be described in more detail below with reference to the accompanying drawings and descriptions thereof.

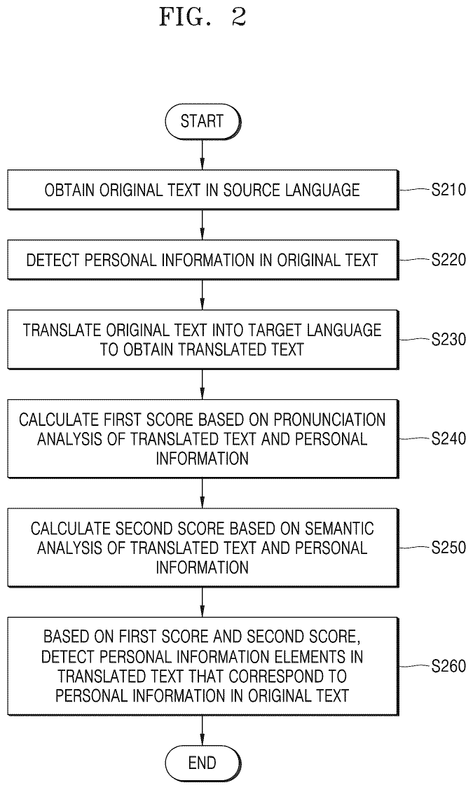

FIG. 2 is a flowchart for illustrating an operation, performed by an electronic device, of detecting personal information, according to an embodiment of the disclosure.

The electronic device according to an embodiment of the disclosure may perform a cross-lingual personal information detection operation, which involves detecting personal information in a text written in a particular language and detecting personal information with the same content in a text that has been translated from the particular language to another language.

In operation S210, the electronic device may obtain an original text in a source language. The original text may be used as input data for the cross-lingual personal information detection operation performed by the electronic device. The original text in the source language may refer to a text written in a particular language (e.g., Korean, English, or Chinese).

In an embodiment of the disclosure, the electronic device may obtain the original text based on a user input. For example, the electronic device may obtain the original text by a user directly inputting the text via a keyboard or through speech recognition.

In an embodiment of the disclosure, the electronic device may obtain a text that is input or output during an interaction with the user, as an input text for a personal information detection operation. For example, while providing or receiving a chatbot service, the electronic device may obtain, as the original text, a text corresponding to the user's question or a text corresponding to a chatbot's response.

In an embodiment of the disclosure, the electronic device may obtain the original text from a text file. For example, the electronic device may obtain text files of various types (e.g., txt, csv, or JSON) and read texts from the files. The text file may be, for example, a security document including personal information, a conversation history between a user and a chatbot, or the like, but is not limited thereto.

In operation S220, the electronic device may detect personal information in the original text.

Personal information may refer to all types of information for identifying an individual. Personal information may include, for example, a name, a gender, a date of birth, an address, an email address, a phone number, a social media account, a resident registration number, a passport number, a driver's license number, and the like, but is not limited thereto. In the disclosure, for convenience of descriptions, a name and an address will be described as primary examples of personal information. However, all descriptions in the disclosure may be applied identically or similarly to all types of personal information elements.

In an embodiment of the disclosure, the electronic device may detect personal information in the original text by using a rule-based detection method. For example, the electronic device may detect personal information in the original text based on keywords or patterns, such as names included in a name database, phone number formats, email address formats, or address formats.

In an embodiment of the disclosure, the electronic device may detect personal information in the original text by using a deep learning-based detection method. For example, the electronic device may use an artificial intelligence model based on an artificial intelligence architecture (e.g., bidirectional encoder representations from transformers (BERT) or long short-term memory (LSTM)) for processing text. The electronic device may collect data from various documents (e.g., texts, emails, or conversation logs) that include personal information, and, based on the collected data, train an artificial intelligence model for detecting personal information from text. A detection model configured to detect personal information may be an artificial intelligence model trained to detect personal information in a source language, and a cross-lingual model described herein may additionally perform a function of the detection model.

In an embodiment of the disclosure, the electronic device may detect personal information in the original text based on a user input. The electronic device may receive a user input to specify personal information in the text. For example, the electronic device may receive a user input to specify the word “ [symbol] ” in the text as personal information representing a name.

In operation S230, the electronic device may translate the original text into a target language to obtain a translated text.

In an embodiment of the disclosure, the target language may be defined by a default value, and refers to a language different from the source language. For example, when the source language is Korean, the target language may be defined as English, Chinese, or the like. Alternatively, when the source language is English, the target language may be defined as a language other than English.

In an embodiment of the disclosure, target language information may be obtained based on a user input. For example, when the source language is Korean, the target language may be determined by a user input to select English, Chinese, or the like as the target language.

The electronic device may translate the original text into the target language. The electronic device may obtain the translated text, which a result of translating the original text into the target language, by using machine translation or deep learning-based translation. In the disclosure, to distinguish between texts written in different languages, expressions such as ‘a first text in a first language’ (e.g., the original text in the source language) and ‘a second text in a second language’ (e.g., the translated text in the target language) may be used.

In an embodiment of the disclosure, the electronic device may translate the original text into an intermediate language. The electronic device may translate the original text into the intermediate language, and then translate the text in the intermediate language into the target language. Translation into an intermediate language may be used, for example, in a case in which direct translation from the original language to the target language is not possible, or in a case in which the context of the original language is more naturally reflected in the target language when translation into the intermediate language is performed. For example, based on language identification information, the electronic device may ensure that an intermediate language translation process is performed for predefined language types.

In operation S240, the electronic device may calculate a first score based on pronunciation analysis of the personal information and the translated text.

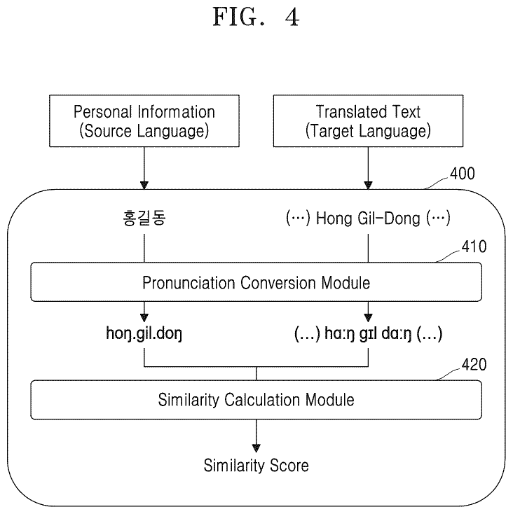

In an embodiment of the disclosure, the electronic device may perform pronunciation analysis to detect corresponding personal information in texts in different languages. Due to the nature of personal information, its pronunciation may be the same or similar even in different languages. The electronic device may analyze the pronunciation of each of texts in different languages to detect words or sentences having similar pronunciations between the texts. For example, ‘personal information A’ may be included in a first text in a first language (the source language) and a second text in a second language (the target language), in respective languages. Through pronunciation analysis of the first text and the second text, the electronic device may detect words or sentences having similar pronunciations. The electronic device may calculate (e.g., identify) a first score representing the similarity in pronunciation to the personal information in the original text. Detailed operations, performed by the electronic device, of performing pronunciation analysis will be described below with reference to FIG. 4.

In operation S250, the electronic device may calculate a second score based on semantic analysis of the personal information and the translated text.

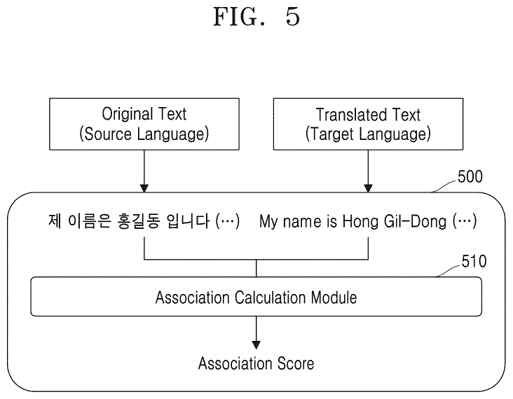

In an embodiment of the disclosure, the electronic device may perform semantic analysis to detect corresponding personal information in texts in different languages. When a text is translated, a word or sentence that is personal information in the original text is likely to also be personal information in the translated text. The electronic device may analyze the meaning of each of texts in different languages to detect words or sentences having similar meanings between the texts. For example, ‘personal information A’ may be included in a first text in a first language (the source language) and a second text in a second language (the target language), in respective languages. Through semantic analysis of the first text and the second text, the electronic device may detect words or sentences having relevance between the texts. The electronic device may calculate a second score representing semantic relevance with the personal information in the original text. Detailed operations, performed by the electronic device, of performing semantic analysis will be described below with reference to FIG. 5.

In operation S260, based on the first score and the second score, the electronic device may detect personal information elements in the translated text that correspond to the personal information in the original text.

In an embodiment of the disclosure, based on the first score, the electronic device may identify, in the translated text, candidate sentences or words having a pronunciation similar to that of the personal information in the original text. For example, the electronic device may sort sentences or words in the translated text in order of the first score, and identify the top N sentences or words as personal information element candidates. Alternatively, for example, the electronic device may identify sentences or words whose first scores are greater than a threshold value, as personal information element candidates.

In an embodiment of the disclosure, based on the second score, the electronic device may identify, in the translated text, candidate sentences or words having a meaning similar to that of the personal information in the original text. For example, the electronic device may sort sentences or words in the translated text in order of the second score, and identify the top M sentences or words as personal information element candidates. Alternatively, for example, the electronic device may identify sentences or words whose second scores are greater than a threshold value, as personal information element candidates.

The electronic device may determine a final personal information element from among personal information element candidates that are identified based on the first score and the second score. The final personal information element may be a sentence or word in the translated text, which corresponds to the personal information in the original text.

For example, the electronic device may determine, as the personal information element, a common element from among first personal information element candidates that are determined based on the first score, and second personal information element candidates that are determined based on the second score. Alternatively, for example, the electronic device may determine, as the personal information element, an element having the highest total score based on a sum of the first score and the second score.

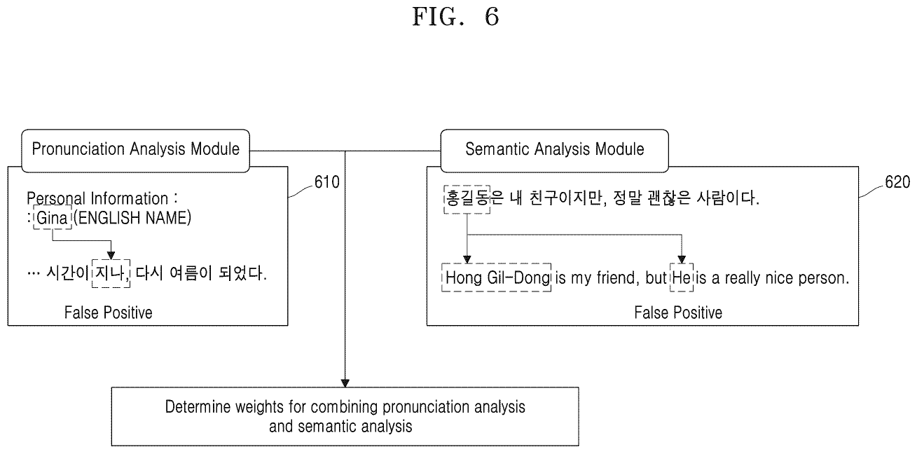

In an embodiment of the disclosure, the electronic device may apply weights based on characteristics of languages and characteristics of personal information. In an embodiment of the disclosure, the electronic device may also use a combination of a weight based on characteristics of languages and a weight based on characteristics of personal information. The electronic device may detect personal information elements in the translated text that correspond to the personal information in the original text, based on a weighted sum of the first score and the second score to which weights have been applied. Operations, performed by the electronic device, of applying weights will be further described below with reference to FIG. 6.

In an embodiment of the disclosure, the electronic device may determine a priority between the pronunciation analysis and the semantic analysis by comparing at least one of the first score or the second score with a threshold value. For example, when, as a result of the pronunciation analysis, there is a word whose first score is greater than or equal to a threshold value, and the first scores of the other words are less than the threshold value, the electronic device may assign a higher priority to the pronunciation analysis. In other words, when it is determined, in an analysis process, that only one word has a high pronunciation similarity and thus the reliability of the pronunciation analysis result is sufficiently high, the pronunciation analysis may be preferentially applied. When the priority of the pronunciation analysis is determined to be high, the electronic device may preferentially apply the pronunciation analysis in a subsequent personal information detection operation, and when the reliability of the pronunciation analysis is sufficiently high (e.g., greater than or equal to a threshold value), the electronic device may omit the semantic analysis. In the same manner, the priority of the semantic analysis may also be adjusted to be high. In this case, when the priority of the semantic analysis is determined to be high, the electronic device may preferentially apply the semantic analysis in a subsequent personal information detection operation, and when the reliability of the semantic analysis is sufficiently high, the electronic device may omit the pronunciation analysis.

In an embodiment of the disclosure, the electronic device may determine the order of the pronunciation analysis and the semantic analysis. For example, when any one analysis method is easier to use than another analysis method, the easier method may be preferentially applied. In detail, when it is difficult to perform the pronunciation analysis because pronunciation information for a particular language is unavailable, the electronic device may preferentially apply the semantic analysis. In addition, for example, when any one analysis method exhibits higher performance than another analysis method, the analysis method with higher performance may be preferentially applied. Such analysis performance may vary depending on the characteristics of the language or the characteristics of the personal information. The priority may be adjusted by a weight.

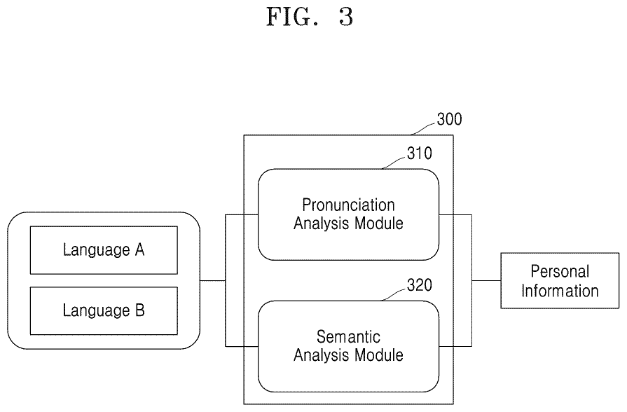

FIG. 3 is a diagram for illustrating an operation, performed by an electronic device, of detecting personal information, according to an embodiment of the disclosure.

In an embodiment of the disclosure, a cross-lingual model 300 may perform a cross-lingual personal information detection operation. For example, the cross-lingual model 300 may detect personal information in various target languages based on personal information detected in a source language. For example, when the source language is ‘Language A’, the cross-lingual model 300 may receive a text written in Language A as input and detect personal information elements. The cross-lingual model 300 may include a detection module trained to detect personal information for Language A, which is the source language. In this case, the detection module may be based on an artificial intelligence architecture (e.g., BERT or LSTM) for processing text. Alternatively, the cross-lingual model 300 may also obtain information about personal information elements based on a user input to specify personal information elements for Language A.

Based on information about personal information elements for the source language, the cross-lingual model 300 may detect personal information elements in a text written in a language different from the source language. For example, when the target language is ‘Language B’, the cross-lingual model 300 may receive a text written in Language B as input and detect personal information elements. Language B may be one or more arbitrary languages different from Language A. For example, when Language A is Korean, Language B may be any arbitrary language different from Korean, such as English, Chinese, or Japanese.

In an embodiment of the disclosure, the cross-lingual model 300 may include a pronunciation analysis module 310 and a semantic analysis module 320.

The pronunciation analysis module 310 analyzes pronunciations in the source language and the target language to enable the identification of personal information elements in the target language. The pronunciation analysis module 310 may include a pronunciation conversion module. The pronunciation conversion module may convert a text representing personal information in an original text in the source language, into phonetic symbols. The pronunciation conversion module may convert a translated text in the target language, into phonetic symbols. The pronunciation analysis module 310 may include a similarity calculation module. The similarity calculation module may calculate a first score representing the similarity between phonetic symbols. Based on the first score, the pronunciation analysis module 310 may identify a personal information element in the target language, which corresponds to the personal information in the source language.

The semantic analysis module 320 analyzes meanings in the source language and the target language to enable the identification of personal information elements in the target language. The semantic analysis module 320 may be based on an artificial intelligence architecture (e.g., transformer) that uses an attention mechanism. An attention module may include an embedding layer that converts the original text in the source language and the translated text in the target language, into vectors. The attention module may calculate relevance between the original text in the source language and the translated text in the target language, to calculate a second score, which is an attention score representing the degree of relevance between words in the respective texts. Based on the second score, the semantic analysis module 320 may identify a personal information element in the target language, which corresponds to the personal information in the source language.

The cross-lingual model 300 may detect personal information elements in the target language, based on the first score and the second score, which are analysis results from the pronunciation analysis module 310 and the semantic analysis module 320, respectively. For example, the cross-lingual model 300 may determine, as a personal information element, a common element from among first personal information element candidates that are determined based on the first score, and second personal information element candidates that are determined based on the second score. For example, the cross-lingual model 300 may determine, as the personal information element, an element having the highest total score based on a sum of the first score and the second score. For example, the cross-lingual model 300 may determine a personal information element by applying a weight corresponding to at least one of characteristics of languages or characteristics of personal information.

In addition, the pronunciation analysis module 310 and the semantic analysis module 320 illustrated in FIG. 3 may be implemented by a processor, included in the electronic device, loading a program or instructions stored in a storage of the electronic device into a memory and then executing the program or instructions. In addition, each module illustrated in FIG. 3 is an example for convenience of descriptions. For example, a single module may be divided into a plurality of modules distinguished according to detailed functions. For example, a translation module configured to perform a translation function may be further included in the cross-lingual model 300. Alternatively, functions of modules that have been described separately herein may be combined with each other and then implemented as a single module.

FIG. 4 is a diagram for illustrating an operation of a pronunciation analysis module of a cross-lingual model, according to an embodiment of the disclosure.

Referring to FIG. 4, a pronunciation analysis module 400 may include a pronunciation conversion module 410 and a similarity calculation module 420.

In an embodiment of the disclosure, the pronunciation conversion module 410 may convert a text in each language into a pronunciation in the corresponding language. For example, the pronunciation conversion module 410 may convert a text to an International Phonetic Alphabet (IPA) transcription. Conversion to an IPA transcription may be performed based on a standard IPA database corresponding to each language.

The pronunciation conversion module 410 may receive, as input, pieces of personal information detected in the original text in the source language, and then convert them to IPA transcriptions. For example, when the source language is Korean, the personal information detected in the original text may be the Korean name [symbol] . Although it is illustrated for convenience of descriptions that there is only one piece of personal information, i.e., [symbol] , a plurality of pieces of personal information may be detected in the original text. The pronunciation conversion module 410 may convert the Korean text [symbol] into the Korean pronunciation [hoη.gil.doη]. In other words, an IPA transcription of the personal information (text) may be obtained.

The pronunciation conversion module 410 may receive, as input, a text translated into the target language, and convert the text to an IPA transcription. For example, when the target language is English, the translated text includes ‘Hong Gil-Dong’, which is an English translation of [symbol] from the original text. The electronic device may translate the entirety of the original text in the source language, and accordingly, the pronunciation conversion module 410 may obtain an IPA transcription of the translated text. For example, ‘Hong Gil-Dong’ included in the translated text may be converted to an IPA transcription, i.e., the English pronunciation [hα:η gIl dα:η].

In an embodiment of the disclosure, the similarity calculation module 420 may calculate a similarity between pronunciations in different languages. For example, the similarity calculation module 420 may calculate a similarity between IPA transcriptions in different languages.

The similarity calculation module 420 may calculate a similarity between the IPA transcription of the personal information and the IPA transcription of the translated text, which are output from the pronunciation conversion module 410. The similarity calculation module 420 may calculate a similarity between IPA transcriptions by using various types of similarity calculation algorithms. For example, the similarity calculation module 420 may use similarity calculation algorithms such as cosine similarity, Euclidean distance, Jaccard similarity, or Levenshtein distance, but is not limited thereto.

For example, the similarity calculation module 420 may calculate a similarity between the IPA transcription of the personal information and the IPA transcription of the translated text, by using cosine similarity. The similarity calculation module 420 may respectively convert the IPA transcription of the personal information and the IPA transcription of the translated text into respective vectors, and calculate a similarity score, Cosine Similarity (IPA₁, IPA₂), representing how similar the respective vectors are in directionality. IPA₁ denotes an IPA transcription of personal information in a source language (a first language), and IPA₂ denotes an IPA transcription of a text translated into a target language (a second language).

For example, the similarity calculation module 420 may calculate a similarity between the IPA transcription of the personal information and the IPA transcription of the translated text, by using Euclidean distance. The similarity calculation module 420 may convert the IPA transcription of the personal information and the IPA transcription of the translated text into respective vectors, and calculate a similarity score, Euclidean Distance (IPA₁, IPA₂), representing a distance between the respective vectors.

For example, the similarity calculation module 420 may calculate a similarity between the IPA transcription of the personal information and the IPA transcription of the translated text, by using Jaccard similarity. With respect to a set of characters of the IPA transcription of the personal information and a set of characters of the IPA transcription of the translated text, the similarity calculation module 420 may calculate a ratio of common elements (intersection) between the sets to all elements (union) of the sets, to calculate a similarity score, Jaccard Similarity (IPA₁, IPA₂), representing how much the symbols used in the two pronunciations overlap.

For example, the similarity calculation module 420 may calculate a similarity between the IPA transcription of the personal information and the IPA transcription of the translated text, by using Levenshtein distance. The similarity calculation module 420 may measure an edit distance between a character string of the IPA transcription of the personal information and a character string of the IPA transcription of the translated text, to calculate a similarity score, Levenshtein Distance (IPA₁, IPA₂), representing how many editing operations may be required to make the two character strings match.

In the above-described similarity calculation algorithms, a cosine similarity and a Jaccard similarity have values between 0 and 1, where a value closer to 1 indicates that the two pieces of data are more similar to each other. In addition, for Euclidean distance and Levenshtein distance, a value closer to 0 indicates that the two pieces of data are more similar to each other.

In an embodiment of the disclosure, the pronunciation analysis module 400 may calculate an overall similarity score by combining similarity scores obtained by using a plurality of similarity analysis algorithms. To combine similarity scores having different characteristics, the pronunciation analysis module 400 may normalize a Euclidean distance and a Levenshtein distance. For example, the normalized Euclidean distance may be 1/(1+Euclidean Distance), the normalized Levenshtein distance may be 1/(1+Levenshtein Distance), and each normalization result has a value between 0 and 1, where a value closer to 1 indicates that the two pieces of data are more similar to each other.

The pronunciation analysis module 400 may calculate an overall similarity score by performing a weighted average combination of the similarity scores or the normalized similarity scores. The overall similarity score may be calculated as follows.

$$Total Score = {w}_{1} \times {Score}_{1} + {w}_{2} \times {Score}_{2} + {w}_{3} \times {Score}_{3} + {w}_{4} \times {Score}_{4}$$

In the equation above, Score₁ may denote a cosine similarity, Score₂ may denote a Jaccard similarity, Score₃ may denote a normalized Euclidean distance, and Score₄ may denote a normalized Levenshtein distance. w₁, w₂, w₃, and w₄ may denote weights for the respective scores, and the sum of the weights may be w₁+w₂+w₃+w₄=1.

By using the pronunciation analysis module 400, the electronic device may calculate a first score, which is a similarity score representing a similarity between the IPA transcription of the personal information and the IPA transcription of the translated text. In the example of FIG. 4, as a result of performing pronunciation analysis on the IPA transcription of the personal information [symbol] , the similarity of the IPA transcription of ‘Hong Gil-Dong’ within the translated text may have a relatively high value, while the similarity of the IPA transcription of the remaining text within the translated text may have a relatively low value.

In an embodiment of the disclosure, the electronic device may apply a weight to a similarity between the IPA transcription of the translated text and the IPA transcription of the personal information, based on phonetic symbol groups of similar phonetic symbols. For example, the pronunciation analysis module 400 may generate phonetic symbol groups by grouping phonetic symbols that have phonetic similarity in IPA transcriptions in the respective languages. The pronunciation analysis module 400 may consider phonetic symbols belonging to the same group in IPA transcriptions in two languages as having high similarity and assign a high weight to the phonetic symbols, and consider phonetic symbols belonging to different groups as having low similarity and assign a low weight to the phonetic symbols. Weights determined based on phonetic symbol groups may be applied to a similarity between the IPA transcription of the translated text and the IPA transcription of the personal information. By applying weights based on phonetic symbol groups, the electronic device may correct for subtle pronunciation differences between different languages. For example, even when the similarity between the IPA transcription of the translated text and the IPA transcription of the personal information is calculated to be relatively low due to subtle pronunciation differences between the languages, but phonetic symbols included in the respective IPA transcriptions belong to corresponding phonetic symbol groups, a weight may be applied to correct the similarity.

FIG. 5 is a diagram illustrating an operation of a semantic analysis module of a cross-lingual model, according to an embodiment of the disclosure.

Referring to FIG. 5, the semantic analysis module 500 may include a relevance calculation module 510. In describing FIG. 5, for convenience of descriptions, Korean will be used as an example of the source language, and English will be used as an example of the target language. In addition, it is assumed for the description that the original text in the source language includes one or more pieces of personal information, and relevance is calculated for the Korean name [symbol] from among the one or more pieces of personal information.

In an embodiment of the disclosure, the relevance calculation module 510 may calculate relevance between words in the original text and words in the translated text. The relevance calculation module 510 may receive, as input, an original text in the source language and a text translated into the target language, and calculate relevance between the two texts. The relevance calculation module 510 may use an attention mechanism (e.g., cross-attention) for the relevance calculation.

For example, the original text may be the Korean sentence [symbol] [symbol] , and the translated text may be the English sentence “My name is Hong Gil-Dong”. The semantic analysis module 500 may convert each sentence into embedding vectors. A pre-trained embedding model such as Word2Vec or BERT may be used for the embedding vectors, but the disclosure is not limited thereto. In the example of FIG. 5, the original text includes four words, [symbol] , [symbol] , [symbol] , and [symbol] , and thus may be converted into four vectors, and the translated text includes five words, “My”, “name”, “is”, “Hong”, and “Gil-Dong”, and thus may be converted into five vectors.

The relevance calculation module 510 may calculate relevance between two sentences by using an attention mechanism. For example, the process of calculating relevance by using an attention mechanism enables an attention score to be obtained by calculating a similarity between a query and a key and then normalizing the similarity. In detail, for example, word vectors of the translated text may correspond to queries, and word vectors of the original text may correspond to keys. In this case, a similarity may be calculated for the query “My” with respect to each of the keys [symbol] , [symbol] , [symbol] , and [symbol] . For calculating the similarity, for example, a dot product and a cosine similarity may be used, but the disclosure is not limited thereto.

The relevance calculation module 510 may calculate an attention score representing relevance between words, by applying a softmax function to the calculated similarity for normalization, as follows.

$$Attention Score {α}_{ij} = Soft max ( Similarity ( Q , K ) )$$

An attention score matrix calculated by applying the example of FIG. 5 to the equation above may be represented as follows.

$$[ \begin{matrix}{α}_{11} & {α}_{12} & {α}_{13} & {α}_{14} \\ {α}_{21} & {α}_{22} & {α}_{23} & {α}_{24} \\ {α}_{31} & {α}_{32} & {α}_{33} & {α}_{34} \\ {α}_{41} & {α}_{42} & {α}_{43} & {α}_{44} \\ {α}_{51} & {α}_{52} & {α}_{53} & {α}_{54}\end{matrix} ]$$

In the matrix above, αᵢⱼ represents an attention score between the i-th word (query) in the translated text and the j-th word (key) in the original text.

In the example of FIG. 5, the word representing personal information in the original text [symbol] [symbol] is [symbol] , and is the third word in the original text. In addition, the words representing personal information in the translated text “My name is Hong Gil-Dong” are “Hong” (last name) and “Gil-Dong” (first name), and these are the fourth and fifth words in the translated text, respectively. (Note: In the example of FIG. 5, because the format of Korean names is such that the last name is written first and the first name is written later, an English name translated from a Korean name is also described as an example where the last name is written first and the first name is written later. However, an English name translated from a Korean name may also have the first name written first and the last name written later, according to the format of English names.)

Based on the attention score, the semantic analysis module 500 may identify words in the translated text that have high relevance with the word corresponding to the personal information in the original text. For example, because the personal information corresponds to the third word in the original text, the semantic analysis module 500 may identify the values of α₁₃, α₂₃, α₃₃, α₄₃, α₅₃ in the attention score matrix. In this case, because the third word in the original text has high relevance with the fourth and fifth words in the translated text, the values of α₄₃, α₅₃ among the values of α₁₃, α₂₃, α₃₃, α₄₃, α₅₃ may be relatively high.

FIG. 6 is a diagram for illustrating an operation, performed by an electronic device, of detecting personal information by combining pronunciation analysis and semantic analysis, according to an embodiment of the disclosure.

When the electronic device uses only pronunciation analysis or only semantic analysis to detect cross-lingual personal information, a false positive may occur, where information that is not actually personal information is detected as personal information. This occurs due to cross-lingual characteristics and personal information characteristics, and the electronic device may use a combination of pronunciation analysis and semantic analysis to prevent false positives.

For example, referring to a first block 610, which shows a result of using only a pronunciation analysis module, the personal information targeted for detection may be the English name “Gina”. In a cross-lingual personal information detection process, when detecting personal information by analyzing pronunciation in a Korean text, a false positive may occur because the word [symbol] in the sentence [symbol] , [symbol] [symbol] (“Time passed, and it became summer again”) is calculated as having a pronunciation similar to that of the word “Gina”. However, in the Korean sentence, [symbol] is not the Korean transliteration of the English name “Gina” but is a word meaning [symbol] (to pass)”. Nevertheless, when cross-lingual personal information is detected based solely on pronunciation, such a false positive may occur.

For example, referring to a second block 620, which shows a result of using only a semantic analysis module, semantic relevance between the Korean text [symbol] [symbol] , [symbol] [symbol] and its translation “Hong Gil-Dong is my friend, but he is a really nice person” may be calculated. While personal information in the Korean text is the Korean name [symbol] , in the English text, “Hong Gil-Dong” and the pronoun “he” may be detected as words having semantic relevance with [symbol] . However, because the pronoun “he” is not personal information, this may be classified as a false positive.

To prevent false positives that may occur due to the characteristics of cross-lingual personal information, the electronic device of the disclosure combines pronunciation analysis and semantic analysis for detecting cross-lingual personal information.

In an embodiment of the disclosure, based on pronunciation analysis, the electronic device may calculate a first score (e.g., a similarity score) representing a similarity of sentences or words in the text translated into the target language with the personal information in the source language. In addition, based on semantic analysis, the electronic device may calculate a second score (e.g., a relevance score) representing relevance of sentences or words in the text translated into the target language with the personal information in the source language. Based on the first score and the second score, the electronic device may identify candidates for personal information elements to be detected in the translated text in the target language, and determine a final personal information element from among the candidates for personal information elements.

In an embodiment of the disclosure, the electronic device may determine weights for combining the pronunciation analysis and the semantic analysis. The weights correspond to characteristics of languages and/or characteristics of personal information, and may be learnable values. For example, a pronunciation weight and a semantic weight corresponding to characteristics of the language “Korean” may be pre-calculated, and a pronunciation weight and a semantic weight corresponding to characteristics of each piece of personal information, such as “name” or “address”, may also be pre-calculated. Based on characteristics of languages and characteristics of personal information, the electronic device may determine weights for combining the pronunciation analysis and the semantic analysis.

In an embodiment of the disclosure, the electronic device may apply weights that reflect characteristics of languages. The weights that reflect characteristics of languages may include a pronunciation weight and a semantic weight. For example, a first language (e.g., a source language) and a second language (e.g., a target language) to be compared with each other may have statistically low pronunciation similarity. In this case, the electronic device may apply a pronunciation weight and a semantic weight such that the second score based on the semantic analysis is reflected more heavily than the first score based on the pronunciation analysis, and calculate a weighted sum of the first score and the second score. Similarly, when the pronunciation similarity between the first language and the second language is high, the electronic device may apply a pronunciation weight and a semantic weight such that the first score based on the pronunciation analysis is reflected more heavily. Pronunciation weights and semantic weights that reflect characteristics of languages may be pre-calculated for the respective languages.

In an embodiment of the disclosure, the electronic device may apply weights that reflect characteristics of personal information. The weights that reflect characteristics of personal information may include a pronunciation weight and a semantic weight. For example, regarding names as personal information, Korean names are listed in the order of last name-first name, and English names are listed in the order of first name-last name. Alternatively, regarding addresses as personal information, Korean addresses are listed in order from a larger scope to a smaller scope (e.g., country-city-building), and English addresses are listed in order from a smaller scope to a larger scope (e.g., building-city-country). Because the degree to which pronunciation similarity or semantic similarity plays an important role differs for each of these personal information characteristics, the electronic device may, according to the personal information characteristics, calculate a weighted sum by applying a pronunciation weight to the first score or applying a semantic weight to the second score. The electronic device may detect personal information elements in the translated text that correspond to the personal information in the original text, based on a weighted sum of the first score and the second score to which weights have been applied.

In an embodiment of the disclosure, the electronic device may also use a combination of a weight based on characteristics of languages and a weight based on characteristics of personal information. For example, the electronic device may calculate a weighted sum of the first score and the second score by using a first pronunciation weight and a first semantic weight, which are based on language characteristics, and a second pronunciation weight and a second semantic weight, which are based on personal information characteristics.

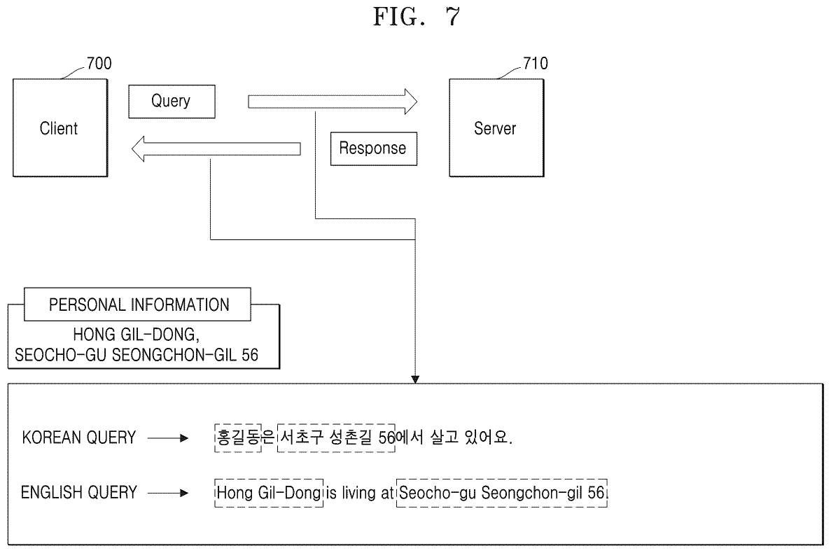

FIG. 7 is a diagram illustrating an example of an operation, performed by an electronic device, of detecting cross-lingual personal information, according to an embodiment of the disclosure.

In an embodiment of the disclosure, the electronic device may perform a security inspection on a conversation between a user and a chatbot. For example, a chatbot system may include a client device 700 and a server 710. The client device 700 may input a query to the server 710, and the server 710 may provide the client device 700 with a response. The server 710 may be a server that operates a language model (e.g., a large language model) for providing a chatbot service.

The chatbot service provides user convenience by responding to user queries. However, responses from the chatbot are not to contain personal information, which is sensitive information. To check and improve security functions for the chatbot service, it may be necessary to detect whether personal information is included in responses from the chatbot. Furthermore, because the chatbot service provides a response in a language corresponding to the language used by the user, it may be necessary to detect whether personal information is included in responses from the chatbot for multiple languages. By using a cross-lingual model, the electronic device may inspect whether personal information is included in a response from the chatbot for various languages with a single model, without changing the model as the language is changed.

In an embodiment of the disclosure, the electronic device may collect conversation content between the client device 700 and the server 710. The electronic device may receive conversation content from the client device 700, or receive conversation content between the user and the chatbot from the server 710. Alternatively, the electronic device, while operating as the client device 700 or the server 710, may also obtain conversation content between the user and the chatbot.

In an embodiment of the disclosure, the electronic device may detect personal information in the conversation content between the user and the chatbot. The electronic device may detect personal information in the conversation content by using a cross-lingual model. Based on personal information elements corresponding to a source language, the cross-lingual model may perform a pronunciation analysis operation and a semantic analysis operation to detect personal information in a text in a target language. The processes of preliminary operations (e.g., personal information detection and translation) and analysis operations (e.g., pronunciation analysis and semantic analysis) required for the cross-lingual model to perform analysis operations have been described with reference to the previous drawings, and thus, redundant descriptions thereof will be omitted.

To describe detection of cross-lingual personal information by the electronic device in conversation content of a chatbot service, detection of personal information [symbol] (Korean name) and [symbol] [symbol] 56” (Korean address) in a source language will be described as an example.

For example, when a Korean query is input to the chatbot, the chatbot may output a Korean response sentence, [symbol] [symbol] [symbol] 56 [symbol] [symbol] (“Hong Gil-Dong is living at Seocho-gu Seongchon-gil 56”). In this case, by using the cross-lingual model, the electronic device may detect personal information [symbol] and [symbol] [symbol] 56” in Korean in a response from the chatbot, to perform a security inspection to inspect whether the chatbot is outputting sensitive personal information.

In addition, when a query in another language is input to the chatbot, the electronic device may inspect, by using the cross-lingual model, whether a response to the query includes sensitive personal information. For example, when an English query is input to the chatbot, the chatbot may output an English response sentence “Hong Gil-Dong is living at Seocho-gu Seongchon-gil 56”. In this case, without changing the model, the electronic device may use the cross-lingual model to detect the personal information “Hong Gil-Dong” and “Seocho-gu Seongchon-gil 56” in English in the response from the chatbot, so as to perform a security inspection to inspect whether the chatbot is outputting sensitive personal information.

The electronic device may perform a chatbot security inspection for various languages and update security functions of the chatbot.

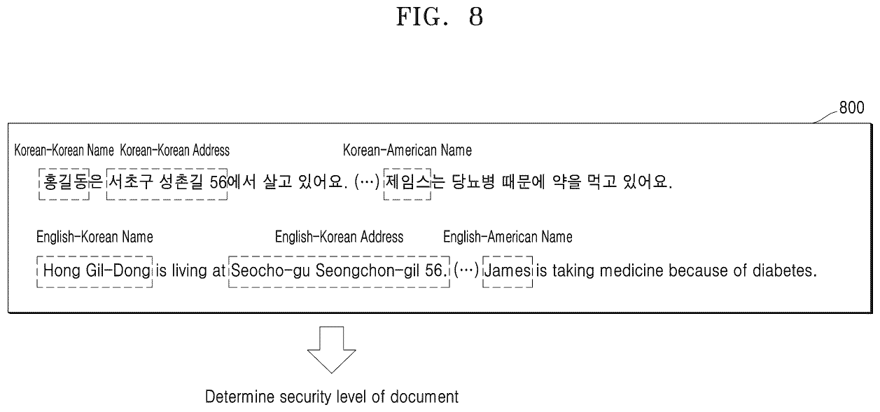

FIG. 8 is a diagram illustrating an example of an operation, performed by an electronic device, of detecting cross-lingual personal information, according to an embodiment of the disclosure.

In an embodiment of the disclosure, the electronic device may perform a security inspection on a document or a database. For example, the electronic device may detect whether personal information, which is sensitive information, is included in a document 800 (or a database including text). The document 800 may be a document in a first language (e.g., Korean), may be a document in a second language (e.g., English), or may be a document in a combination of the first language and the second language. Alternatively, the document 800 may include two or more languages.

The electronic device may detect personal information in the document 800 by using a cross-lingual model. The cross-lingual model detects personal information by using pronunciation analysis and semantic analysis, and thus may detect personal information regardless of the language in which the personal information is written.

For example, in the Korean sentence [symbol] [symbol] [symbol] 56 [symbol] [symbol] (“Hong Gil-Dong is living at Seocho-gu Seongchon-gil 56”), {Korean-Korean name: [symbol] } and {Korean-Korean address: [symbol] [symbol] 56} may be detected. In addition, for example, in the Korean sentence [symbol] [symbol] [symbol] [symbol] (“James is taking medicine because of diabetes”), {Korean-American name: [symbol] (James)} may be detected. This means that even when personal information representing an English name is written in Korean, the cross-lingual model may detect it as personal information.

For example, in the English sentence “Hong Gil-Dong is living at Seocho-gu Seongchon-gil 56”, {English-Korean name: Hong Gil-Dong} and {English—Korean address: Seocho-gu Seongchon-gil 56} may be detected. This means that even when personal information representing a Korean name is written in English, and even when a Korean address is written in English, the cross-lingual model may detect them as personal information. In addition, for example, in the English sentence “James is taking medicine because of diabetes”, {English-American name: James} may be detected.

In other words, the electronic device may detect personal information in different languages by using a single cross-lingual model, without a change to a language model corresponding to the corresponding language whenever the language is changed.

In an embodiment of the disclosure, in addition to detecting cross-lingual personal information within a single document, the electronic device may also perform a security inspection on original documents and their translations. For example, by using a single cross-lingual model, the electronic device may perform a security inspection that involves performing a personal information detection operation on an original document and its translations.

In an embodiment of the disclosure, based on personal information elements detected in the document 800 (or personal information elements detected in a database), the electronic device may determine a protection level for the document. For example, the electronic device may set access rights to a document based on the number of detected personal information elements. Alternatively, based on the types of detected personal information elements, the electronic device may apply protection processing (e.g., masking) to at least some of the personal information elements.

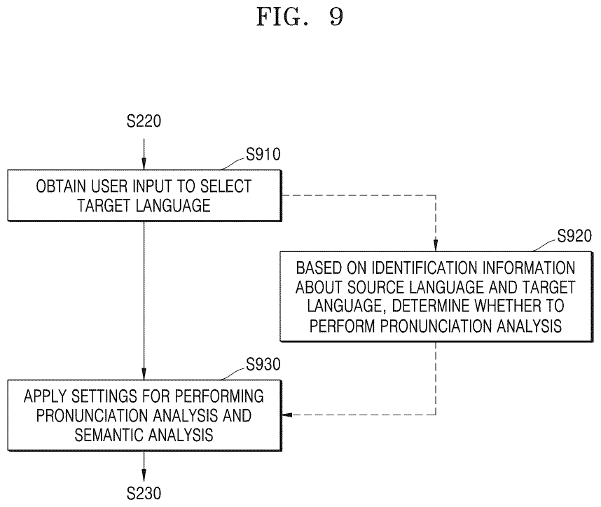

FIG. 9 is a flowchart for illustrating an operation, performed by an electronic device, of applying settings for personal information detection, according to an embodiment of the disclosure.

In operation S910, the electronic device may obtain a user input to select a target language. Operation S910 may be performed after operation S220 of FIG. 2 is performed. For example, when the source language is a first language (e.g., Korean), the electronic device may obtain a user input to select, as the target language, a second language (e.g., English), which is different from the first language.

In operation S920, based on identification information about the source language and the target language, the electronic device may determine whether to perform pronunciation analysis.

Because languages differ in their pronunciation systems and phonological rules, there may be languages appropriate for performing pronunciation analysis and languages inappropriate for performing pronunciation analysis. For example, pronunciation comparison may be appropriate for languages with similar pronunciation systems or common rules, but it may be inappropriate for languages whose pronunciation rules are somewhat different from those of other languages (e.g., languages where the meaning of a word is determined by tones, or languages with voiceless consonants). The electronic device may determine whether to perform pronunciation analysis, based on predefined information regarding whether to perform pronunciation analysis between a source language and a target language.

In an embodiment of the disclosure, operation S920 may be omitted. In other words, operation S930 may be performed immediately after operation S910 is performed. In this case, pronunciation analysis is performed without condition.

In operation S930, the electronic device may apply settings for performing pronunciation analysis and semantic analysis.

When the source language and the target language are determined, the electronic device may load settings for performing pronunciation analysis and semantic analysis between the languages. For example, the electronic device may load IPA information about the source language for pronunciation conversion of the source language, and IPA information about the target language for pronunciation conversion of the target language, and apply the IPA information as settings for pronunciation analysis. In addition, for example, the electronic device may load a translation model for translation between the source language and the target language, and apply the translation model as settings for semantic analysis. In an embodiment of the disclosure, translation between the source language and the target language may include loading a translation model for translation into an intermediate language, which is a third language.

After operation S930 is performed, operation S230 of FIG. 2 may be performed. Subsequent operations have been described with reference to FIG. 2, and thus, redundant descriptions thereof will be omitted.

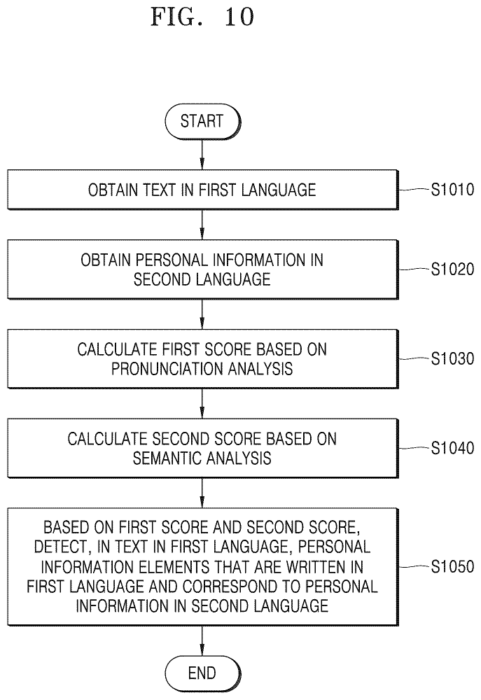

FIG. 10 is a flowchart for illustrating an operation, performed by an electronic device, of detecting personal information, according to an embodiment of the disclosure.

In operation S1010, the electronic device may obtain a text in a first language. The text in the first language may refer to a text on which the electronic device is to perform a personal information detection operation. The electronic device may obtain a text based on a user input, obtain a text from a stored text file, or obtain a text from an external device. When the text in the first language is obtained, the electronic device may start operations for detecting one or more personal information elements within the text in the first language. In this case, the electronic device may detect that personal information, which was originally in a second language, has been written in the first language as a result of translation or the like.

In operation S1020, the electronic device may obtain personal information in the second language. The second language may refer to a language that is different from the first language. For example, when the first language is Korean, the second language may be English. The personal information in the second language may include, for example, a name, a gender, a date of birth, an address, an email address, a phone number, a social media account, a resident registration number, a passport number, a driver's license number, and the like, but is not limited thereto.

In operation S1030, the electronic device may calculate a first score based on pronunciation analysis.

In an embodiment of the disclosure, the electronic device may convert the text in the first language into a phonetic representation. For example, the electronic device may convert the text in the first language into an IPA transcription corresponding to the first language. In addition, the electronic device may convert the personal information in the second language into a phonetic representation. For example, the electronic device may convert the personal information in the second language into an IPA transcription corresponding to the second language. The electronic device may calculate a similarity between the IPA transcription of the text in the first language and the IPA transcription of the personal information in the second language, to calculate a first score representing the degree of similarity.

In an embodiment of the disclosure, the electronic device may determine personal information element candidates based on the first score. For example, based on whether the first score is greater than a first threshold value, the electronic device may determine first personal information element candidates in the text in the first language. Alternatively, for example, the electronic device may detect first personal information element candidates in the text in the first language, based on the top N words having high first scores.

In operation S1040, the electronic device may calculate a second score based on semantic analysis.

For example, the electronic device may translate the entirety of the text in the first language into the second language. The electronic device may calculate a second score representing relevance between the text translated into the second language and the personal information in the second language. The relevance calculation may be based on an attention score obtained by using an attention mechanism, but is not limited thereto. Based on whether the second score is greater than a second threshold value, the electronic device may determine second personal information element candidates in the text in the first language. Alternatively, for example, the electronic device may detect second personal information element candidates in the text in the first language, based on the top M words having high second scores.

In an embodiment of the disclosure, for example, the electronic device may translate only the first personal information element candidates, which are personal information element candidates determined based on the first score, into the second language. The electronic device may calculate second scores representing respective levels of relevance between the first personal information element candidates translated into the second language and the personal information in the second language. The electronic device may reduce the amount of computation by translating, into the second language, only the first personal information element candidates detected in the text in the first language, instead of translating the entirety of the text in the first language. The relevance calculation may be an attention score obtained by using an attention mechanism, but is not limited thereto.

In operation S1050, based on the first score and the second score, the electronic device may detect, in the text in the first language, personal information elements that are written in the first language and correspond to the personal information in the second language.

The electronic device may determine a final personal information element from among the personal information element candidates that are identified based on the first score and the second score. One or more final personal information elements may be determined, and each final personal information element may include cross-lingual personal information. The cross-lingual personal information refers to personal information that is written in the first language and corresponds to the personal information in the second language. For example, personal information written in the first language and corresponding to the English name “James”, which is personal information in the second language, may be the Korean name [symbol] (“James”). In other words, the English name [symbol] written in Korean may be detected in the text written in the first language.

In an embodiment of the disclosure, the electronic device may determine, as a personal information element, a common element from among the first personal information element candidates that are determined based on the first score, and the second personal information element candidates that are determined based on the second score. Alternatively, the electronic device may determine, as a personal information element, an element having the highest total score based on a sum of the first score and the second score.

In an embodiment of the disclosure, after translating only the first personal information element candidates determined based on the first score and then calculating second scores, the electronic device may determine, as a personal information element, an element whose second score is greater than or equal to a threshold value. Alternatively, after translating only the first personal information element candidates determined based on the first score and then calculating second scores, the electronic device may determine, as a personal information element, an element whose second score is the highest.

In an embodiment of the disclosure, the electronic device may apply weights based on characteristics of languages and characteristics of personal information. The electronic device may apply a weight to the first score or the second score. Detailed operations associated with the application of weights have been described with reference to the previous drawings, and thus, redundant descriptions thereof will be omitted.

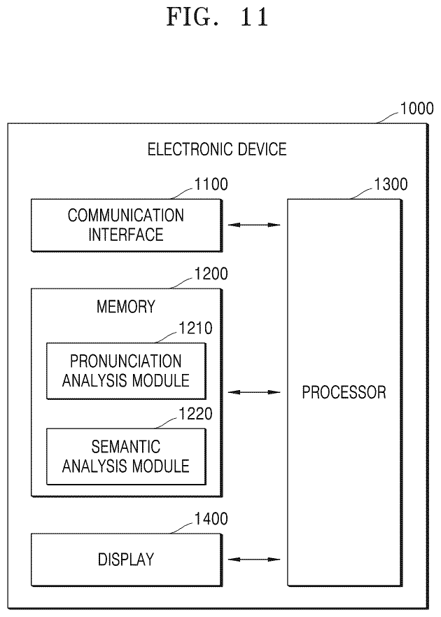

FIG. 11 is a block diagram illustrating a configuration of an electronic device according to an embodiment of the disclosure.

In an embodiment of the disclosure, an electronic device 1000 may include a communication interface 1100, a memory 1200, a processor 1300, and a display 1400.

The communication interface 1100 may perform data communication with other electronic devices, under control of the processor 1300.

The communication interface 1100 may perform data communication between the electronic device 1000 and another electronic device by using at least one of data communication methods including, for example, a wired local area network (LAN) (e.g., Ethernet), wireless LAN (e.g., Wi-Fi), a cellular network (e.g., 4G or 5G), Bluetooth, Bluetooth Low Energy (BLE), ZigBee, Infrared Data Association (IrDA), near-field communication (NFC), radio-frequency (RF) communication, or other various types of known wireless/wired communication technologies. The communication interface 1100 may include a communication circuit designed to use the above-described communication methods.

By using the communication interface 1100, the electronic device 1000 may transmit and receive, to and from another electronic device, data for detecting cross-lingual personal information. For example, the electronic device 1000 may transmit and receive, to and from another electronic device, input data for a cross-lingual model (e.g., a text) and/or output data from the cross-lingual model (e.g., a personal information detection result), and may receive, from another electronic device, a model for performing a personal information detection operation (e.g., a cross-lingual model or a translation model).

The memory 1200 may include various types of memory. The memory 1200 may include a main memory configured to store data currently being processed by the electronic device 1000. For example, the main memory may include a volatile memory such as random-access memory (RAM) or static RAM (SRAM), but is not limited thereto. The memory 1200 may include a secondary memory configured to permanently store a large amount of data (e.g., programs or system files). For example, the secondary memory may include a non-volatile memory including at least one of a hard disk drive (HDD), a solid-state drive (SSD), an optical drive (e.g., a compact disc (CD)), a flash drive, ROM, electrically erasable programmable ROM (EEPROM), or programmable ROM (PROM), but is not limited thereto.

The memory 1200 may store one or more instructions and one or more programs that cause the electronic device 1000 to operate to detect and provide cross-lingual personal information. For example, the memory 1200 may store instructions and programs for implementing functions of a pronunciation analysis module 1210 and a semantic analysis module 1220. The modules stored in the memory 1200 may be examples for convenience of descriptions, and the disclosure is not limited to these examples. Other modules may be added to implement the above-described embodiments of the disclosure, and some modules may be omitted. In addition, one module may be divided into a plurality of modules distinguished from each other according to their detailed functions, and some of the above-described modules may be combined and implemented as one module.

The processor 1300 may control overall operations of the electronic device 1000. The processor 1300 may include processing circuitry. For example, by executing one or more instructions of a program stored in the memory 1200, the processor 1300 may control overall operations for the electronic device 1000 to detect and process cross-lingual personal information. One or more processors 1300 may be provided.

For example, the processor 1300 may include, but is not limited to, at least one of a central processing unit (CPU), a microprocessor, a graphics processing unit (GPU), an application-specific integrated circuit (ASIC), a digital signal processor (DSP), a digital signal processing device (DSPD), a programmable logic device (PLD), a field-programmable gate array (FPGA), an application processor (AP), a neural processing unit (NPU), or a dedicated artificial intelligence processor designed in a hardware structure specialized for processing an artificial intelligence model.

By executing the pronunciation analysis module 1210, the processor 1300 may perform a pronunciation analysis operation for detecting cross-lingual personal information. The pronunciation analysis module 1210 may calculate a similarity score representing a pronunciation similarity between sentences or words in respective languages by analyzing pronunciations between different languages. Descriptions associated with the operations of the pronunciation analysis module 1210 have already been provided with reference to the previous drawings, and thus, redundant descriptions thereof will be omitted.

By executing the semantic analysis module 1220, the processor 1300 may perform a semantic analysis operation for detecting cross-lingual personal information. The semantic analysis module 1220 may calculate a relevance score representing semantic relevance between sentences or words in respective languages by analyzing meanings between different languages. Descriptions associated with the operations of the semantic analysis module 1220 have already been provided with reference to the previous drawings, and thus, redundant descriptions thereof will be omitted.

In an embodiment of the disclosure, one or more processors 1300 may be provided. In a case in which one or more processors 1300 are provided, the operations of the disclosure may be performed by the one or more processors individually or collectively executing instructions and/or a program stored in the memory 1200. In a case in which a method according to an embodiment of the disclosure includes a plurality of operations, the plurality of operations may be performed by one processor 1300 or by a plurality of processors 1300.

For example, when a first operation, a second operation, and a third operation are performed by the method according to an embodiment of the disclosure, the first operation, the second operation, and the third operation may all be performed by a first processor, or some of the first to third operations may be performed by the first processor (e.g., a general-purpose processor) and the other operations may be performed by a second processor (e.g., a dedicated artificial intelligence processor). Here, a dedicated artificial intelligence processor, which is an example of the second processor, may perform operations for learning/inference of an artificial intelligence model. However, an embodiment of the disclosure is not limited thereto.

The one or more processors according to the disclosure may be implemented as a single-core processor or a multi-core processor. In a case in which a method according to an embodiment of the disclosure includes a plurality of operations, the plurality of operations may be performed by one core or by a plurality of cores included in the one or more processors.

The display 1400 may output an image signal on a screen of the electronic device 1000, under control of the processor 1300. The display 1400 may output, on the screen, an image signal processed during a process in which the electronic device 1000 detects cross-lingual personal information. For example, the display 1400 may display an input field for text input, a text list for selecting an input text file, a text search result, a selected text, and the like, and may display a result of detecting cross-lingual personal information in a text. The display 1400 may include a touch panel. The touch panel may include one or more touch sensors configured to detect a touch input. In an embodiment of the disclosure, a user input associated with a cross-lingual personal information detection operation may be obtained through the touch panel.

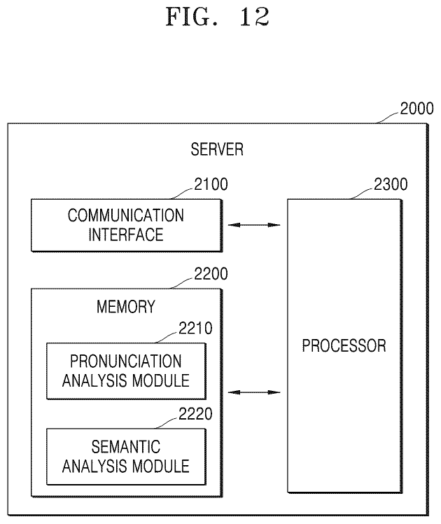

FIG. 12 is a block diagram illustrating a configuration of a server according to an embodiment of the disclosure.

In an embodiment of the disclosure, a server 2000 may include a communication interface 2100, a memory 2200, and a processor 2300. The operations of the electronic device 1000 described above with reference to the previous drawings may be performed by the server 2000.

The communication interface 2100, the memory 2200, and the processor 2300 of the server 2000 of FIG. 12 may respectively correspond to the basic functions described above with reference to the communication interface 1100, the memory 1200, and the processor 1300 of the electronic device 1000 of FIG. 11. Thus, for the sake of brevity, redundant descriptions thereof will be omitted. The memory 2200 may store instructions and programs for implementing functions of a pronunciation analysis module 2210 and a semantic analysis module 2220.

The server 2000 may be a computing device configured with hardware elements having higher-performance specifications than the electronic device 1000, so as to handle complex computations and tasks for processing large-scale data generated in a process of operating a cross-lingual model. Thus, the respective components of the server 2000 are similar in function to the respective components of the electronic device 1000, but may have higher specifications in terms of performance (e.g., computational capabilities or computational speed).

The server 2000 may receive, from a client device (e.g., a user device), a request for a personal information detection operation using a cross-lingual model, perform a cross-lingual personal information detection operation based on pronunciation analysis and semantic analysis, and provide a result of detecting personal information to the client device as a response.

The disclosure relates to an electronic device and method for detecting personal information elements in text by using a single cross-lingual model capable of detecting personal information in a plurality of different languages. The technical objectives of the disclosure are not limited to those mentioned above, and other technical objectives not mentioned herein may be clearly understood by those of skill in the art to which the disclosure pertains from the description herein.

According to an aspect of the disclosure, there may be provided a method, performed by an electronic device, of detecting personal information.

The method may include obtaining a first text in a first language.

The method may include detecting personal information in the first text.

The method may include obtaining a second text by translating the first text into a second language.

The method may include calculating a first score based on pronunciation analysis of the personal information and the second text.

The method may include calculating a second score based on semantic analysis of the personal information and the second text.

The method may include detecting, in the second text, personal information elements corresponding to the personal information in the first text, based on the first score and the second score.

The calculating of the first score may include converting the personal information and the second text into IPA transcriptions.

The calculating of the first score may include calculating the first score representing a similarity between the IPA transcription of the second text and the IPA transcription of the personal information.

The calculating of the first score may include applying a weight to the similarity between the IPA transcription of the second text and the IPA transcription of the personal information, based on a phonetic symbol group generated by grouping similar phonetic symbols.

The calculating of the second score may include calculating the second score representing relevance between the first text and the second text, by applying an attention mechanism.

The obtaining of the second text may include translating the first text into a third language, which is an intermediate language.

The obtaining of the second text may include obtaining the second text by translating, into the second language, a third text, which is a result of the translating into the third language.

The method may include applying, to at least one of the first score or the second score, a weight corresponding to at least one of language characteristics or personal information characteristics.

The method may include determining a priority between the pronunciation analysis and the semantic analysis by comparing at least one of the first score or the second score with a threshold value.

The method may include obtaining a user input to select the second language.

The method may include applying settings for performing the pronunciation analysis and the semantic analysis, based on identification information about the first language and the second language.

The method may include determining whether to perform the pronunciation analysis, based on the identification information about the first language and the second language.

The method may include determining a protection level for a document including the second text, based on the personal information elements detected in the second text.

According to an aspect of the disclosure, there may be provided an electronic device for detecting personal information.

The electronic device may include a communication interface, at least one processor, and a memory storing instructions.

The instructions, when executed by the at least one processor, may cause the electronic device to obtain a first text in a first language.

The instructions, when executed by the at least one processor, may cause the electronic device to detect personal information in the first text.

The instructions, when executed by the at least one processor, may cause the electronic device to obtain a second text by translating the first text into a second language.

The instructions, when executed by the at least one processor, may cause the electronic device to calculate a first score based on pronunciation analysis of the personal information and the second text.

The instructions, when executed by the at least one processor, may cause the electronic device to calculate a second score based on semantic analysis of the personal information and the second text.

The instructions, when executed by the at least one processor, may cause the electronic device to detect, in the second text, personal information elements corresponding to the personal information in the first text, based on the first score and the second score.

The instructions, when executed by the at least one processor, may cause the electronic device to convert the personal information and the second text into IPA transcriptions.

The instructions, when executed by the at least one processor, may cause the electronic device to calculate the first score representing a similarity between the IPA transcription of the second text and the IPA transcription of the personal information.

The instructions, when executed by the at least one processor, may cause the electronic device to apply a weight to the similarity between the IPA transcription of the second text and the IPA transcription of the personal information, based on a phonetic symbol group generated by grouping similar phonetic symbols.

The instructions, when executed by the at least one processor, may cause the electronic device to calculate the second score representing relevance between the first text and the second text, by applying an attention mechanism.

The instructions, when executed by the at least one processor, may cause the electronic device to translate the first text into a third language, which is an intermediate language.

The instructions, when executed by the at least one processor, may cause the electronic device to obtain the second text by translating, into the second language, a third text, which is a result of the translating into the third language.

The instructions, when executed by the at least one processor, may cause the electronic device to apply, to at least one of the first score or the second score, a weight corresponding to at least one of language characteristics or personal information characteristics.

The instructions, when executed by the at least one processor, may cause the electronic device to determine a priority between the pronunciation analysis and the semantic analysis by comparing at least one of the first score or the second score with a threshold value.

The instructions, when executed by the at least one processor, may cause the electronic device to obtain a user input to select the second language.

The instructions, when executed by the at least one processor, may cause the electronic device to apply settings for performing the pronunciation analysis and the semantic analysis, based on identification information about the first language and the second language.

The instructions, when executed by the at least one processor, may cause the electronic device to determine whether to perform the pronunciation analysis, based on the identification information about the first language and the second language.

The instructions, when executed by the at least one processor, may cause the electronic device to determine a protection level for a document including the second text, based on the personal information elements detected in the second text.

Embodiments of the disclosure may be implemented as a recording medium including computer-executable instructions such as a computer-executable program module. The computer-readable medium may be any available medium which is accessible by a computer, and may include a volatile or non-volatile medium and a detachable and non-detachable medium. Also, the computer-readable medium may include a computer storage medium and a communication medium. The computer storage media include both volatile and non-volatile, detachable and non-detachable media implemented in any method or technique for storing information such as computer readable instructions, data structures, program modules or other data. The communication medium may include computer-readable instructions, data structures, or other data of a modulated data signal such as program modules.

In addition, the computer-readable storage medium may be provided in the form of a non-transitory storage medium. Here, the term ‘non-transitory’ merely means that the storage medium does not refer to a transitory electrical signal but is tangible, and does not distinguish whether data is stored semi-permanently or temporarily on the storage medium. For example, the ‘non-transitory storage medium’ may include a buffer in which data is temporarily stored.

According to an embodiment of the disclosure, methods according to various embodiments disclosed herein may be included in a computer program product and then provided. The computer program product may be traded as commodities between sellers and buyers. The computer program product may be distributed in the form of a machine-readable storage medium (e.g., a CD-ROM), or may be distributed online (e.g., downloaded or uploaded) through an application store or directly between two user devices (e.g., smart phones). In a case of online distribution, at least a portion of the computer program product (e.g., a downloadable app) may be temporarily stored in a machine-readable storage medium such as a manufacturer's server, an application store's server, or a memory of a relay server.

While the disclosure have been particularly shown and described, it will be understood by one of ordinary skill in the art that various changes in form and details may be made therein without departing from the spirit and scope of the disclosure. Therefore, it should be understood that the above-described embodiments of the disclosure are exemplary in all respects and do not limit the scope of the disclosure. For example, each component described as being unitary may also be implemented in a distributed manner, and similarly, components described as being distributed may be implemented in a combined form.

The scope of the disclosure is not limited by the detailed description of the disclosure but by the following claims, and all modifications or alternatives derived from the scope and spirit of the claims and equivalents thereof fall within the scope of the disclosure.

What is claimed is:

1. A method, performed by an electronic device, of detecting personal information, the method comprising:
obtaining a first text in a first language;
detecting personal information in the first text;
obtaining a second text by translating the first text into a second language;
identifying a first score based on a pronunciation analysis of the personal information and the second text;
identifying a second score based on a semantic analysis of the personal information and the second text; and
detecting, in the second text, personal information elements corresponding to the personal information in the first text, based on the first score and the second score.

2. The method of claim 1, wherein the identifying the first score comprises:
converting the personal information and the second text into International Phonetic Alphabet (IPA) transcriptions; and
identifying the first score representing a similarity between an IPA transcription of the second text and an IPA transcription of the personal information.

3. The method of claim 2, wherein the identifying the first score comprises applying a weight to the similarity between the IPA transcription of the second text and the IPA transcription of the personal information, based on a phonetic symbol group generated by grouping similar phonetic symbols.

4. The method of claim 1, wherein the identifying the second score comprises identifying the second score representing relevance between the first text and the second text, by applying an attention mechanism.

5. The method of claim 4, wherein the obtaining of the second text comprises:
translating the first text into a third language, which is an intermediate language; and
obtaining the second text by translating, into the second language, a third text, which is a result of the translating into the third language.

6. The method of claim 1, further comprising applying, to at least one of the first score or the second score, a weight corresponding to at least one of language characteristics or personal information characteristics.

7. The method of claim 1, further comprising determining a priority between the pronunciation analysis and the semantic analysis by comparing at least one of the first score or the second score with a threshold value.

8. The method of claim 1, further comprising:
obtaining a user input to select the second language; and
applying settings for performing the pronunciation analysis and the semantic analysis, based on identification information about the first language and the second language.

9. The method of claim 8, further comprising determining whether to perform the pronunciation analysis, based on the identification information about the first language and the second language.

10. The method of claim 1, further comprising determining a protection level for a document comprising the second text, based on the personal information elements identified in the second text.

11. An electronic device comprising:
a communication interface;
at least one processor; and
a memory storing instructions,
wherein the instructions, when executed by the at least one processor, cause the electronic device to:
obtain a first text in a first language;
detect personal information in the first text, obtain a second text by translating the first text into a second language;
identify a first score based on a pronunciation analysis of the personal information and the second text;
identify a second score based on a semantic analysis of the personal information and the second text; and
detect, in the second text, personal information elements corresponding to the personal information in the first text, based on the first score and the second score.

12. The electronic device of claim 11, wherein the instructions, when executed by the at least one processor, cause the electronic device to:
convert the personal information and the second text into International Phonetic Alphabet (IPA) transcriptions; and
identify the first score representing a similarity between an IPA transcription of the second text and an IPA transcription of the personal information.

13. The electronic device of claim 12, wherein the instructions, when executed by the at least one processor, cause the electronic device to apply a weight to the similarity between the IPA transcription of the second text and the IPA transcription of the personal information, based on a phonetic symbol group generated by grouping similar phonetic symbols.

14. The electronic device of claim 11, wherein the instructions, when executed by the at least one processor, cause the electronic device to identify the second score representing relevance between the first text and the second text, by applying an attention mechanism.

15. The electronic device of claim 11, wherein the instructions, when executed by the at least one processor, cause the electronic device to translate the first text into a third language, which is an intermediate language, and obtain the second text by translating, into the second language, a third text, which is a result of the translating into the third language.

16. The electronic device of claim 11, wherein the instructions, when executed by the at least one processor, cause the electronic device to apply, to at least one of the first score or the second score, a weight corresponding to at least one of language characteristics or personal information characteristics.

17. The electronic device of claim 11, wherein the instructions, when executed by the at least one processor, cause the electronic device to determine a priority between the pronunciation analysis and the semantic analysis by comparing at least one of the first score or the second score with a threshold value.

18. The electronic device of claim 11, wherein the instructions, when executed by the at least one processor, cause the electronic device to obtain a user input to select the second language, and apply settings for performing the pronunciation analysis and the semantic analysis, based on identification information about the first language and the second language.

19. The electronic device of claim 18, wherein the instructions, when executed by the at least one processor, cause the electronic device to determine whether to perform the pronunciation analysis, based on the identification information about the first language and the second language.

20. A non-transitory computer-readable recording medium having recorded thereon a program for causing a computer to execute a method comprising:
obtaining a first text in a first language;
detecting personal information in the first text;
obtaining a second text by translating the first text into a second language;
identifying a first score based on a pronunciation analysis of the personal information and the second text;
identifying a second score based on a semantic analysis of the personal information and the second text; and
detecting, in the second text, personal information elements corresponding to the personal information in the first text, based on the first score and the second score.
